(19) United States
(12) Patent Application Publication
(10) Pub. No.: US 2008/0169932 A1
(43) Pub. Date: Jul. 17, 2008

(54) Vibration Alert Method and Monitor System

(75) Inventors: Craig Desrosiers, Spring City, PA (US); Jeffrey Swan, West Chester, PA (US)

Correspondence Address: LEMPIA BRAIDWOOD LLC, 223 W. JACKSON BLVD., SUITE 620, CHICAGO, IL, 60606, US

(73) Assignee: Graco Children's Products Inc., Exton, PA (US)

(21) Appl. No.: 11/735,783

(22) Filed: Apr. 16, 2007

Related U.S. Application Data
(60) Provisional application No. 60/885,310, filed on Jan. 17, 2007.

(51) Int. Cl. G08B 23/00

(52) U.S. Cl. 340/573.1; 340/500

(57) ABSTRACT

Disclosed herein are child monitor systems and methods in which a device includes a receiver that receives a wireless signal including audio data indicative of sounds captured at a remote location. The receiver includes a demodulator to derive a digital data stream from the wireless signal. The device further includes a processor coupled to the receiver to obtain the digital data stream and configured to analyze the digital data stream to determine whether to initiate a vibration alert. In some cases, a transmitter device includes a processor configured to generate a vibration alert command based on an analysis of the digital audio data and for incorporation in the wireless signal.

### CROSS-REFERENCE TO RELATED APPLICATION

This application claims the benefit of U.S. provisional application Ser. No. 60/885,310, entitled “Vibration Alert Method and Monitoring System,” and filed Jan. 17, 2007, the entire disclosure of which is hereby expressly incorporated by reference.

### BACKGROUND OF THE DISCLOSURE

1. Field of the Disclosure

The present disclosure is generally directed to child monitor systems, and more particularly to child monitor systems capable of generating a vibration alert.

2. Brief Description of Related Technology

Conventional child monitor systems typically have a receiver (or caregiver unit) and a transmitter (or child unit) that communicate wirelessly with one another. The transmitter is typically placed in the nursery, room or other environment occupied by the child, and the receiver is typically placed remote from the child's environment in a room or location occupied by the caregiver. In operation, the child unit captures sounds and, in some cases, images, and transmits representative data to the caregiver unit, at which point the data is converted back into the sounds and images for playback.

Some caregiver units have been designed for portability, enabling the unit to be carried or worn by the caregiver. In such cases, the receiver may provide a vibration alert to supplement the playback of the sounds captured by the child unit. For instance, vibration alerts have been provided to inform the caregiver that the captured sounds have exceeded a certain sound level.

Several commercially available child monitor devices have a vibration alert feature. The Calming Vibrations monitor available from Fisher Price as model no. 71644, the Walkabout Recharge monitor available from Tomy as model no. 1230, the AnyWear Compact monitor available from Safety 1st as model no. 08046, and the Whisper Connect Vibra monitor available from Evenflo, provide such functionality based on analog wireless FM transmissions. In these systems, the caregiver unit compares the amplitude of the analog transmission data with a threshold to determine whether the captured sounds warrant the activation of a vibration motor. For further descriptions of vibration alert functionality based on analog audio transmissions, see U.S. Pat. No. 7,009,520 and U.S. Patent Publication No. 2003/0067390.

Unfortunately, the analog transmission of data between the transmitter and receiver may be undesirably limiting.

Child monitor systems have been designed to communicate via digital wireless transmissions. For example, the imonitor™ monitor products available from Graco Children's Products as models nos. 2791 and 2795 transmit audio data digitally. The digital transmissions utilized by these systems have carried information other than the data representative of the captured sounds. The transmitter can send an identification, or privacy, code to the receiver during a startup routine. The transmitter can also send a command to the receiver to activate a parent unit finder feature. Still further digital child monitor systems have captured video for transmission with the audio.

### SUMMARY OF THE DISCLOSURE

In accordance with one aspect of the disclosure, a child monitor device includes a receiver to receive a wireless signal comprising audio data indicative of sounds captured at a remote location, the receiver including a demodulator to derive a digital data stream from the wireless signal. The child monitor device further includes a processor coupled to the receiver to obtain the digital data stream and configured to analyze the digital data stream to determine whether to initiate a vibration alert, a vibration motor to vibrate the child monitor device in accordance with the vibration alert, a digital-to-analog converter coupled to the microprocessor to receive the audio data from the digital data stream for conversion, and a speaker output coupled to the digital-to-analog converter to reproduce the sounds captured at the remote location in accordance with the audio data.

In some cases, the processor is configured to determine whether to initiate the vibration alert based on whether the digital data stream comprises a vibration alert command. The processor may then be configured to decompress the digital data stream to seek a vibration alert command transmitted in a packet of the digital data stream separately from audio data packets of the digital data stream carrying the audio data. Alternatively or additionally, the processor is configured to detect a characteristic of the audio data to determine whether to initiate the vibration alert.

In some cases, the wireless signal further includes image data indicative of images captured at the remote location. The processor may then be configured to detect a characteristic of the image data to determine whether to initiate the vibration alert. The characteristic may be indicative of a brightness difference in the images captured in successive frames of the image data. Alternatively or additionally, the characteristic may be indicative of a color difference in the images captured in successive frames of the image data. Alternatively or additionally, the characteristic may be indicative of motion between the images captured in successive frames of the image data.

In accordance with another aspect of the disclosure, a child monitor system includes a first unit having a transducer to capture sounds, an analog-to-digital converter to generate digital audio data representative of the sounds, and an RF transmitter to generate an RF signal carrying the digital audio data. The child monitor system also includes a second unit configured to receive the RF signal wirelessly and having a vibration motor and an RF receiver to generate a digital data stream from the RF signal. The first unit further includes a processor configured to generate a vibration alert command based on an analysis of the digital audio data and configured to provide the vibration alert command to the RF transmission module for incorporation in the RF signal. The second unit also includes a processor to control operation of the vibration motor in accordance with the vibration alert command.

In some cases, the processor of the first unit is configured to detect a characteristic of the audio data to determine whether to initiate the vibration alert.

The first unit may further include a camera such that the RF signal further includes image data indicative of images captured by the camera. The processor of the first unit may then be configured to detect a characteristic of the image data to determine whether to initiate the vibration alert. In some cases, the characteristic is indicative of a brightness difference in the images captured in successive frames of the image data. Alternatively or additionally, the characteristic may be indicative of a color difference in the images captured in successive frames of the image data. Alternatively or additionally, the characteristic may be indicative of motion between the images captured in successive frames of the image data.

In accordance with yet another aspect of the disclosure, a child monitor method includes generating a digital data stream comprising audio data representative of captured sounds and image data representative of captured images, evaluating a characteristic of the digital data stream via analysis of the digital data stream, and generating a vibration alert command in accordance with the analysis.

In some cases, the child monitor method further includes the step of modifying the digital data stream to include the vibration alert command. The child monitor method may then further include the step of receiving an RF signal representative of the modified digital data stream. The evaluating step may then include determining whether the vibration alert command is included within the modified digital data stream.

Alternatively or additionally, the child monitor method further includes the step of receiving an RF signal representative of the digital data stream, where the evaluating step is performed after the receiving step.

In accordance with yet another aspect of the disclosure, a child monitor system includes a first unit having a microphone to capture audio data, a camera to capture video data, and an RF transmitter to generate an RF signal carrying the audio data and the video data. The child monitor system further includes a second unit having an RF receiver to derive a digital data stream from the RF signal, a vibration motor, and a processor to analyze the digital data stream to control operation of the vibration motor. The operation of the vibration motor is controlled based on an audio/video (A/V) characteristic of either the audio data or the video data.

### BRIEF DESCRIPTION OF THE DRAWING FIGURES

Objects, features, and advantages of the present disclosure will become apparent upon reading the following description in conjunction with the drawing figures, in which like reference numerals identify like elements in the figures, and in which:

FIG. 1 is a block diagram of an exemplary child monitor system having caregiver and child units configured for digital communication of sound data and a vibration alert command in accordance with one embodiment;

FIG. 2 is a block diagram of another exemplary child monitor system having caregiver and child units configured for digital communication of sound data, image data and a vibration alert command in accordance with another embodiment;

FIG. 3 is a block diagram of yet another exemplary child monitor system having caregiver and child units configured for digital communication of sound and image data and processing of the communicated data for initiation of a vibration alert in accordance with yet another embodiment;

FIG. 4 is a block diagram of an exemplary digital data stream for digital communication between the caregiver and child units of one of the exemplary embodiments of FIGS. 1-3;

FIG. 5 is a block diagram of another exemplary digital data stream for digital communication between the caregiver and child units of one of the exemplary embodiments of FIGS. 1-3;

FIG. 6 is a flow diagram of an exemplary child monitor technique for the generation and transmission of a vibration alert command in accordance with one embodiment;

FIG. 7 is a flow diagram of an exemplary child monitor technique for the reception and implementation of the vibration alert command generated via the technique of FIG. 6; and,

FIG. 8 is a flow diagram of an exemplary child monitor technique for the reception of a digital transmission of audio/video (A/V) data and activation of a vibration motor in accordance with another embodiment.

While the disclosed systems, devices and methods are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION OF PREFERRED EMBODIMENTS

Described below are child monitor systems, devices and techniques that implement a vibration alert in connection with captured sounds or images (or both). To this end, the disclosed techniques, devices and systems communicate data representative of the captured sounds or images via digital transmissions. In some cases, the digital transmissions also carry a vibration alert command. More generally, a vibration alert is implemented based on analysis of an audio/video characteristic of the transmitted audio/video data.

Although described in connection with exemplary child monitor systems involving the capture of audio or image data for a caregiver, the disclosed techniques, devices and systems are well suited for implementation and use in a variety of contexts and applications. Practice of the disclosed techniques, devices and systems is accordingly not limited to a particular child monitoring context or application.

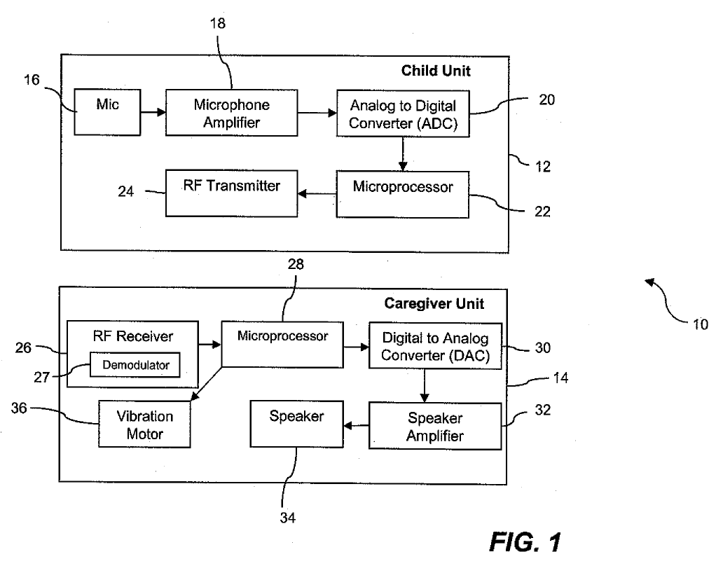

FIG. 1 depicts an exemplary child monitor system indicated generally at 10 in which at least two devices (or units) are configured for wireless communication. In the system 10, a child unit 12, which may be located in a nursery, communicates with a parent or caregiver unit 14, which may be a handheld, portable, wearable, or otherwise mobile unit. Additional child or caregiver units may be integrated or incorporated, as desired. Generally speaking, the child unit 12 captures sound via a microphone or transducer 16 and wirelessly transmits data indicative of the captured sound via a digital transmission to the caregiver unit 14.

The exemplary child unit 12 includes a number of analog and digital components to capture the sound and generate digital audio data for transmission. At the outset, the sounds encountered in the nursery or other monitoring location are converted to an analog signal with the microphone transducer 16 and a microphone amplifier 18. Next, the analog signal is converted to digital data by an analog-to-digital converter (ADC) 20. In this exemplary case, the digital data is then processed for incorporation into a wireless signal by a microprocessor 22, although alternative child units may utilize any one or more of a variety of processing units, such as an application specific integrated circuit (ASIC), digital signal processor, etc. coupled to the ADC 20. The processing may involve or implement any one or more techniques to support the digital transmission of the audio data, such as compression, encryption, organization into a data stream of packets, etc. The processing may also include or involve analysis or other procedures directed to the generation and incorporation of additional information or data, such as alerts and other commands, to be transmitted as part of the digital data stream with the audio data. Further details regarding examples of such processing and incorporation are provided below. Once processed into a digital data stream (e.g., sequences of packets) to be transmitted, the digital audio data (and any other information) is provided to a digital RF transmitter 24 for further processing and modulation. Generally speaking, the RF transmitter 24 modulates an RF carrier signal (e.g., 900 MHz or 2.4 GHz) with the packets of the digital data stream from the microprocessor 22. The RF transmitter is coupled to an antenna or other apparatus (not shown) configured for propagation of the RF signal as a wireless signal.

With continued reference to the exemplary embodiment of FIG. 1, reception of the wireless signal and processing of the digital transmission by the caregiver unit 14 are now described. As a general matter, the caregiver unit 14 is configured to receive the wireless signal to generate, or reproduce, the sounds captured by the child unit 12, as well as act on any commands, alerts or other information received via the transmitted digital data stream. To those ends, the wireless signal is received by an antenna or other apparatus (not shown) coupled to an RF receiver 26, which may demodulate and otherwise process the wireless signal to derive (e.g., reconstruct or generate) the digital data stream. To that end, the receiver 26 may include a demodulator 27 integrated with other components of the receiver 26 to any desired extent. Further demodulation, decompression and other processing techniques may be implemented by a microprocessor 28 coupled to the RF receiver 26. The microprocessor 28 may parse and otherwise process the data stream to determine, for instance, which portions of the data stream are representative of audio data. The audio portion of the digital data stream is then converted into an analog waveform or signal by a digital-to-analog converter (DAC) 30 coupled to a speaker amplifier 32. The speaker amplifier 32 amplifies the analog signal to drive a speaker output 34 for reproduction of the captured sounds. In some cases, the speaker output 34 includes an output port (e.g., headphone jack) for connection of headphone or other speaker wires, cords, etc. Alternatively or additionally, the speaker output 34 includes a speaker or other transducer for production of the sounds.

In accordance with one aspect of the disclosure, the child and caregiver units 12, 14 of the exemplary monitor system 10 of FIG. 1 also support the generation of a vibration alert based on a digital vibration alert command. To this end, the caregiver unit 14 includes a vibration motor 36 controlled by the microprocessor 28 in accordance with the digital vibration alert command. The vibration motor 36 may include, for example, an electric motor with an eccentrically mounted weight, as well as any driver circuitry. The driver circuitry may be, for instance, responsive to a digital command from the microprocessor 28 to supply current to the electric motor for operation thereof.

A vibration alert may arise from and, thus, be designed to indicate, a variety of different circumstances, some examples of which are described in connection with the exemplary embodiments below. Generally speaking, issuing or implementing a vibration alert may be provided in conjunction with the captured sound reproduction, or as part of an alternative mode of operation (e.g., a quiet or silent mode) in which reproduction of the captured sounds is muted, disabled or otherwise unavailable.

In some cases, digital data representative of the vibration alert command may be transmitted wirelessly between the units 12, 14 along with the digital data representative of the audio. For example, the vibration alert command may be sent with or associated with a message, packet, frame or time period of audio data. To that end, the command may include an indication of the frame or time period during which the caregiver unit 14 should vibrate.

In the exemplary embodiment of FIG. 1, the microprocessor 22 of the child unit 12 generally determines if a vibration alert should be issued or generated based on one or more properties or characteristics of the captured sound. This determination may include or involve analysis to detect an audio amplitude greater than a preset or otherwise selected threshold. Other embodiments may include more complex analysis of the sound to, for instance, evaluate or identify a characteristic that may be indicative of sounds made by the child. For example, the property or characteristic of the captured sound may be its frequency spectrum, and the analysis may involve evaluating certain frequencies that correspond with sounds typically made by a child. In this way, the audio amplitude analysis may be augmented or replaced by digital signal processing techniques such as filtering, frequency analysis, etc. In these and other cases, the microprocessor 22 may include a chip or circuit dedicated to performing the routines or calculations involved in the analysis. Consequently, the microprocessor 22 is not limited to an implementation involving a single general-purpose processor, but rather may include any number of special- or general-purpose processing units, chips or circuits.

Based on the outcome of the data analysis, the microprocessor 22 of the child unit 12 generates a command packet (or packet component or other digital data set) for wireless transmission to the caregiver unit 14. Upon reception of the data packet(s), the microprocessor 28 of the caregiver unit 14 responds to the vibration alert command by directing the vibration motor 36 to be turned on or otherwise activated.

In the exemplary embodiment of FIG. 1, the digital data stream received by the caregiver unit 14 is decompressed, parsed and otherwise processed by the microprocessor 28 to look for a vibration alert command. As described below, the vibration alert command may be transmitted as a separate packet or be integrated with the other digital data in the data stream in accordance with any desired transmission protocol or scheme. When a vibration alert command packet is encountered, the microprocessor 28, in turn, directs or commands the vibration motor 36 to turn on for either a time period specified in the command, for a predetermined, default or otherwise selected time period, or until a subsequent packet or other unit of received digital data is found to not include a vibration alert command.

The exemplary embodiment described above and in connection with FIG. 1 implements a vibration alert technique based on analysis of the audio data generated from the sounds captured by the child unit 12 of the system 10. The exemplary embodiments described below may alternatively or additionally include or involve analysis of non-audio data to support the generation of a vibration alert command, such as image data gathered at the child unit.

The exemplary embodiments described below also address the implementation of the underlying analysis at either the child unit 12, the caregiver unit 14, or both. That is, the processing that determines whether to generate a vibration alert command, or initiate a vibration alert, may occur either before the data transmission between units of the system 10, after the transmission, or both before and after the transmission. Allocating or distributing the processing burden in a manner different from the embodiment of FIG. 1 may help address cases where the vibration alert determination involves or requires data or information stored or available only at the caregiver unit 14. For example, the vibration alert command may be generated based on one or more criteria selected or established at the caregiver unit 14. In such cases, it may nonetheless be beneficial to process the data at the child unit 12 to at least a certain extent before transmission to the caregiver unit 14, as the caregiver unit 14 may be designed for lower power consumption and, thus, less processing power, in the interest of portability, battery life, etc.

Described below are exemplary embodiments in which the issuance of a vibration alert command may be based on one or more characteristics or properties of an image in a video monitor system. The video monitor system may be used in conjunction with an audio system, such as the one described above, such that generation of the vibration alert command may be based on both an audio evaluation as well as video or image analysis.

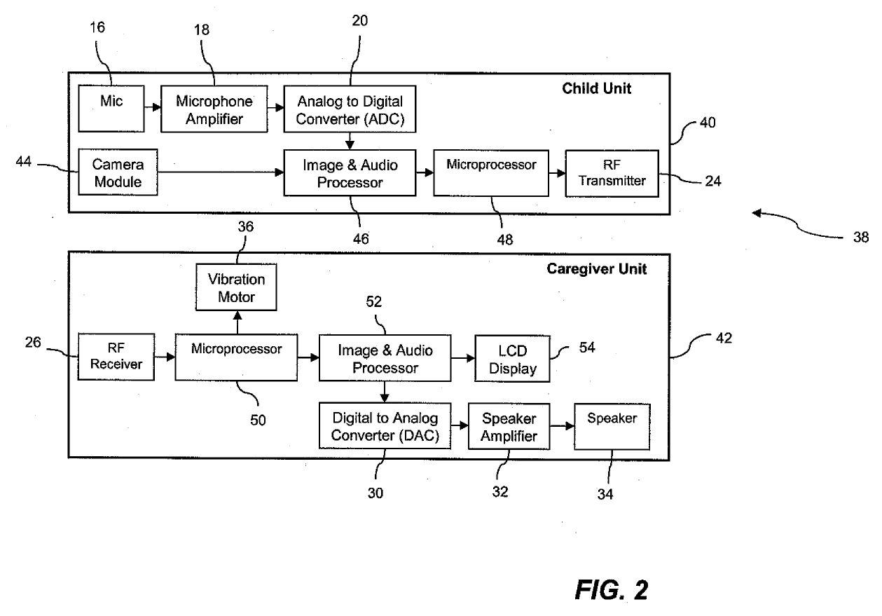

Turning now to the exemplary embodiment shown in FIG. 2, a monitor system indicated generally at 38 incorporates a vibration alert feature based on evaluation of audio data, non-audio data, or both. The system 38 includes a child unit 40 and a caregiver unit 42 configured for communication via digital transmissions, as described above. In fact, the microphone transducer 16, the microphone amplifier 18, the ADC 20 and the RF transmitter 24 of the child unit 40 may be substantially similar, if not identical, to the corresponding components of the child unit 12 of FIG. 1. In this exemplary embodiment, however, the child unit 40 further includes a camera module 44 to capture images at the monitoring site. Each image of the environment at the monitoring site may be arranged in a data set provided by an image sensor array. The camera module 44 may include one or more lenses, apertures, image sensor arrays, and other components directed to attaining a desired or selected resolution, image capture rate, etc. The image capture rate may vary from photographs taken every few seconds to rates suitable for sequences of video frames.

Data representative of one or more images may be fed to an image and audio processor 46, which may be programmed or otherwise configured to perform a number of procedures on the non-audio data from the camera module 44. For example, the data from the camera module 44 may be in a raw or other preliminary format, and the image and audio processor 46 may implement one or more compression, compilation, filtering or other procedures to present the data in a more refined or convenient format. As part of such procedures, the image and audio processor 46 may combine, compile or otherwise integrate the audio data from the ADC 20 with the image data from the camera module 44. Alternatively or additionally, the image and audio processor 46 may be programmed or otherwise configured to implement procedures directed to evaluating the audio data, the image data, or both, for the purpose of determining whether a vibration alert command should be issued. To these ends, the image and audio processor 46 (and any other processor described herein) may include a digital signal processor (DSP), an ASIC, or other hardware or firmware, distributed over any number of chips or circuits, as desired. In some embodiments, the image and audio processor 46 includes a commercially available microcontroller integrated circuit (IC) chip, such as an audio/video chip having a multimedia processor. One example of a suitable audio/video chip is available from Winbond Electronics Corp. (www.winbond.com) as product no. W99702G. Such chips may be configured to include any number of codecs for audio and video (image) processing in accordance with conventional data protocols (e.g., MPEG). To that end, the chip (and, more generally, the image and audio processor 46) may include embedded memory, as desired. In some cases, the functionality provided by the DAC 20 may be implemented using the same hardware, software or firmware responsible for implementing the functionality of the image and audio processor 46.

The child unit 40 may also include a microprocessor 48 coupled to the image and audio processor 46 as shown in FIG. 2. Generally speaking, the microprocessor 48 may arrange the audio and video data from the image and audio processor 46 into packets of data suitable for transmission. In some cases, the microprocessor 48 may include a general-purpose processor directed to controlling various functionality in the child unit 40, including the preparation of a digital data stream for transmission via the RF transmitter 24. In that sense, the microprocessor 48 may be programmed or otherwise configured in a manner similar to the microprocessor 22 of FIG. 1. Such cases may include those in which the image and audio processor 46 is directed to implementing the analysis procedures involved in the vibration alert determination. Alternatively or additionally, the microprocessor 48 is programmed or otherwise configured to implement some or all of the analysis involved in the vibration alert determination. To that end, the image and audio processor 46 may prepare the audio and image data in a manner suitable for analysis. Alternative embodiments may have the functionality of the image and audio processor 46 and the microprocessor 48 integrated to any desired extent, such that some or all of the firmware or hardware is shared for the aforementioned procedures.

In some cases, the vibration alert determination and, accordingly, the generation of a vibration alert command, is handled by one or both of the processors 46, 48 of the child unit 40. In other cases, the determination and generation procedures are handled at the caregiver unit 42. In still other cases, the steps taken in these procedures may be shared between the processors of the child and caregiver units 40, 42.

The caregiver unit 42 of the exemplary embodiment of FIG. 2 includes a microprocessor 50 and an image and audio processor 52 for processing of the digital data stream received by the RF receiver 26. The processing steps implemented by the microprocessor 50 may involve or include determining whether a vibration alert command has been received. The microprocessor 50 may accordingly send a command or other signal to the vibration motor 36 to initiate the alert. The processing steps may alternatively or additionally include evaluation of the received audio data, the non-audio data, or both, in connection with determining whether an alert should be initiated. As an initial matter, however, the microprocessor 50 may also be responsible for decompiling, decoding and otherwise preparing the received digital data stream for further processing by the image and audio processor 52. To that end, the microprocessor 50 may remove the audio data, the image data, and other information from the digital data stream (and packets thereof) for separate processing. As with each of the processors described herein, the microprocessor 50 may include a general-purpose processor or DSP programmed or otherwise configured to implement the foregoing procedures, or may include one or more ASICs or other hardware or firmware directed to the procedures. In this exemplary case, the microprocessor 50 delivers the portions of the digital data stream containing the audio data and the non-audio data to the image and audio processor 52, which, in turn, may decompress, process and otherwise prepare the image data for display via a display 54, such as an LCD display. The image and audio processor 52 also directs the audio data to the DAC 30 after processing to any desired extent. In these and other respects, the image and audio processor 52 may be similar in form and functional capability to the image and audio processor 46 of the child unit 40, and may be integrated with the microprocessor 50 to any desired extent.

In some cases, the vibration alert feature may be activated or controlled by evaluating properties of non-audio data captured by the child unit 40. Regardless of which unit 40, 42 is responsible for the analysis and determination, the vibration alert is activated when one or more criteria are met. Criteria may be selected by a user via, for instance, one or more controls at one of the units 40, 42, and need not be limited to characteristics of the captured images. Rather, the criteria may involve any logical combination of factors involving the captured images (image data), the captured sounds (audio data), and user-selected factors, such as thresholds, etc. Evaluating the audio/visual (A/V) characteristics of the captured images and sounds may involve a variety of evaluation techniques and processing of the non-audio data and the audio data.

Of those A/V characteristics involving the non-audio data, examples of properties or aspects of the captured images (or video) that may be used as criteria for the vibration alert determination include the following: (i) a change in overall brightness of the image from one frame to the next; (ii) a change in overall color of the image from one frame to the next; and, (iii) a degree of motion detection, which may include or involve, for instance, detection of a change in a certain percentage of pixels from one frame to the next.

Of those A/V characteristics involving the audio data, examples of properties of the captured sounds that may be used as criteria for the vibration alert determination include the following: (i) amplitude (e.g., relative to a threshold); and, (ii) frequency spectrum profile (e.g., matching those profiles indicative of sounds made by a child).

More generally, the analysis or evaluation involving an A/V characteristic may be threshold-based. In some cases, the threshold may be directed to a change in the observed or measured value (or other derivative) of the A/V characteristic.

Any one of the thresholds for an A/V characteristic utilized in the vibration alert determination may be adjustable via a control provided via one or both of the units 40, 42. Adjusting the threshold via such controls may generally adjust the sensitivity of the evaluation involving the A/V characteristic, as well as the vibration alert determination more generally.

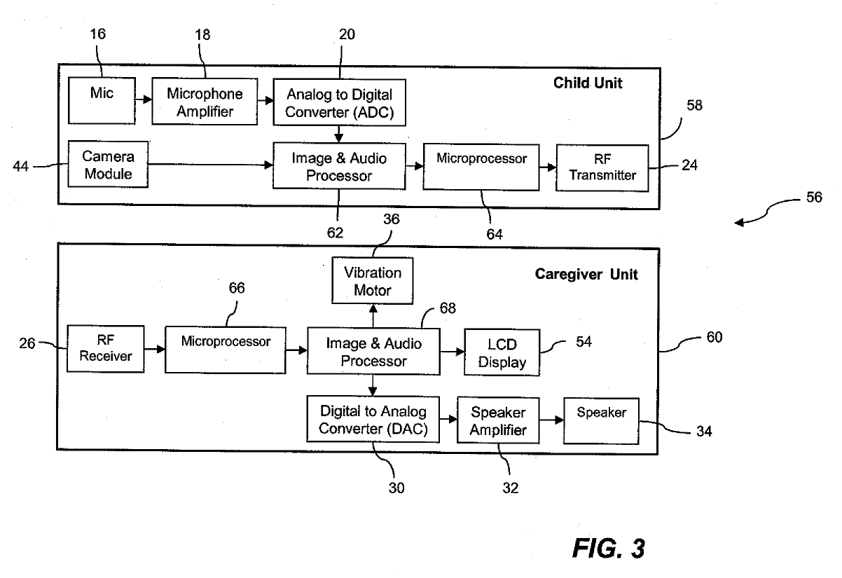

FIG. 3 depicts an exemplary system indicated generally at 56 having a number of aspects in common with the embodiment of FIG. 2, as well as a number of variations. Both embodiments include components (i.e., the camera module 44, the LCD display 54, etc.) directed to the capture, processing and display of images, but the one or more A/V characteristics utilized in the vibration alert determination need not involve the data resulting from the captured images. Both a child unit 58 and a caregiver unit 60 of the system 56 may include a number of components in common with the counterpart units shown and described in the embodiments of FIGS. 1 and 2. In some cases, the analog and digital hardware of the embodiments of FIGS. 2 and 3 may be similar, if not identical, and only differing in the firmware or software configuration details.

In the exemplary embodiment of FIG. 3, the child unit 58 is not responsible for the generation of a vibration alert command for transmission with the digital data stream. As a consequence, some or all of the underlying evaluation and analysis of the captured sound or images (i.e., the A/V characteristic(s)) may be implemented by the caregiver unit 60. For example, the child unit 58 may include an image and audio processor 62 and a microprocessor 64 programmed or otherwise configured to generate the digital data stream having the audio and non-audio data. The other components of the child unit 58 may be similar, if not identical, to the corresponding components of the embodiment of FIG. 2.

The caregiver unit 60 includes a microprocessor 66 and an image and audio processor 68 programmed or otherwise configured to implement the procedures related to receiving the digital data stream, decompressing the data, and controlling the LCD display 54 and audio components. In addition to those procedures, one or both of the microprocessor 66 and the image and audio processor 68 are programmed or otherwise configured to implement the analysis underlying the vibration alert determination. As shown in the exemplary embodiment of FIG. 3, the image and audio processor 68 is eventually responsible for generating a command to direct the vibration motor 36. In the interim, however, the microprocessor 66 may be programmed or otherwise configured to implement the underlying analysis and generate a vibration alert command for the image and audio processor 68. Alternatively, the image and audio processor 68 may be programmed or otherwise configured to evaluate the decompressed audio data, image data, or both, to determine whether to generate the only vibration alert command.

Some portion of the evaluation and analysis may be alternatively performed at the child unit 58 as described above. In such cases, the microprocessor 64 of the child unit 58 may generate and incorporate preliminary information (e.g., A/V characteristic data), or an intermediate command (e.g., issue alert if certain conditions are met) into the data stream for transmission to the parent unit 60. The microprocessor 66 of the parent unit 60 may then, in response to the intermediate command, implement or direct further evaluation or analysis toward whether to generate a vibration alert command for the image and audio processor 68 or the vibration motor 36, and thereby initiate a vibration alert. Any one of these commands (or the signals carrying them) may be considered “a vibration alert command,” as that term is used herein. In some instances, the vibration alert command may be internal to one of the microprocessors or image and audio processors.

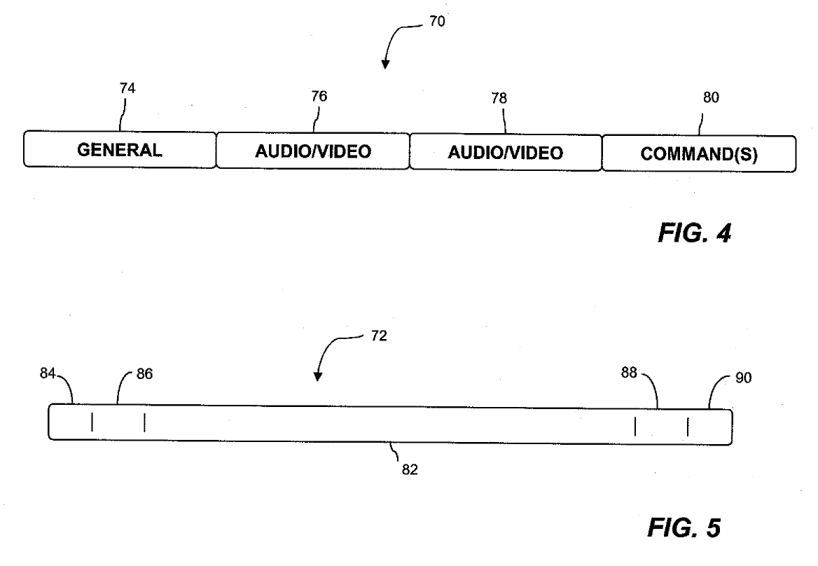

FIGS. 4 and 5 depict exemplary digital data streams indicated generally at 70 and 72. The two data streams 70, 72 illustrate two alternative data transmission protocols, or configurations, of the numerous schemes suitable for the communications between the monitor units. Generally speaking, however, the two data streams 70, 72 are directed to carrying packets, or frames, of non-audio data, audio data, or both (“audio/video data” or “A/V data”), as well as any other commands or information transmitted between the units. The A/V data may be encoded, multiplexed or otherwise arranged within each portion of the stream 70, 72 in a wide variety of ways, and is not limited to the exemplary arrangements shown and described.

In FIG. 4, the data stream 70 includes a number of packets, each of which is dedicated to a different type of data. The specialization of the packets of this example allows the packet structure to be of a short length. In this example, a general packet (or segment) 74 of information (e.g., operational status, mode, time, etc.) is followed by a pair of A/V data packets 76 and 78, which, in turn, are followed by a command packet 80. This pattern may, but need not, be repeated in subsequent transmissions. Moreover, any number of A/V data packets may follow or precede a general packet or a command packet. Each packet may have its own trailer section for error detection and other purposes, as well as a header section for synchronization, identification and other purposes. In between the header and trailer sections of each packet is a payload section carrying the principal data and information to be conveyed by the packet.

One example of the short packet structure shown in FIG. 4 arranges each of the packets 74, 76, 78, 80 in a four-byte configuration. The general packet 74 may have a first byte dedicated to a header that identifies the data contents of the packet, second and third bytes directed to the data contents, and a fourth byte for a checksum or cyclical redundancy check (CRC) to verify the validity of the transmission. An exemplary short packet structure for an audio data packet may begin with a first byte having a value (e.g., 0×4D) that identifies the data to follow as audio data, second and third bytes having values (e.g., 0×34 and 0×21) to identify the audio data, and a fourth validity check byte. An exemplary short packet structure for a command packet may begin with a first byte having a value (e.g., 0×CC) indicative of a MOTOR-ON command, second and third bytes having values (e.g., 0×CC and 0×CC) to identify any data associated with the vibration alert, and a fourth validity check byte.

The exemplary protocol of FIG. 4 configures the transmissions such that any commands are communicated separately from the A/V data. Thus, a vibration alert command may be transmitted separately (e.g., in the packet 80) from the A/V data with which it may be associated. In some cases, the command packet 80 is designed to only contain the command to activate the vibration motor, and thus does not include any other commands or information, much less A/V data.

Such short packet transmissions may be advantageous, insofar as the effects of transmission errors may be more limited, or contained. For example, sending short packets that only contain one piece of audio data allows for fine detection of transmission errors. An audio packet with an error can be discarded with little impact on the quality of sound reproduction. If a packet contains a large amount of audio data, any error would result in all of the audio data being discarded, with a potentially significant impact on sound quality. To avoid the potential for negative impacts with short packets for the audio, it may be useful to transmit commands separately from the audio data via, e.g., separate packets for any commands.

The command packet 80 may include an information set containing any number of parameters for the vibration alert. For example, the command packet 80 may specify a duration for the alert. Alternatively, the command packet 80 may identify an A/V packet with which the vibration alert is associated, such that the duration of the alert corresponds with the duration of the A/V packet data. In yet another embodiment, the command packet 80 may specify an initiation of the alert, while a subsequent packet then specifies a termination of the alert. Other parameters that may be specified by the command packet 80 include adjustments to the vibration alert, such as a change in vibration intensity level or vibration motor speed, each of which may be used to indicate a certain change in A/V characteristics. Other examples include adjustments to the vibration alert threshold(s) or criteria selections.

The command packet 80 may alternatively or additionally contain information unrelated to the vibration alert command, such as other commands or instructions for the caregiver unit. Exemplary commands, instructions and other information include adjusting the wireless transmission frequency channel, adjusting the sensitivity of the image sensors, and switching between operational modes or speeds of the camera (e.g., adjusting the image capture rate). These instructions or commands may trigger the microprocessor or other component to implement corresponding modifications to the vibration alert analysis.

In the exemplary protocol of FIG. 5, the A/V data and command data are generally combined or integrated in a payload section 82 of the packet 72. The payload section 82 may be preceded by one or more header sections 84, 86 and followed by one or more trailer sections 88, 90 for checksum, CRC or other purposes. The payload section 82 may have a predetermined order for the organization and presentation of different types of information. For example, the first three bytes of data in the payload section 82 may be directed to commands and information, with the following 50 bytes of data directed to A/V data. In this case, the larger (e.g., 50+ byte) packet size allows for a much larger amount of A/V data to be transmitted in one packet and, thus, be conveniently associated with a single vibration alert command. This example also shows how some embodiments may involve the transmission of a single packet containing audio data, image data, and other information and commands, including the vibration alert command.

Notwithstanding any of the foregoing description of the exemplary data packet protocols of FIGS. 4 and 5, portions or aspects of the vibration alert command may be distributed over any number of packets or packet sections. Moreover, portions or aspects of the vibration alert command may be included in different types of packets or packet sections.

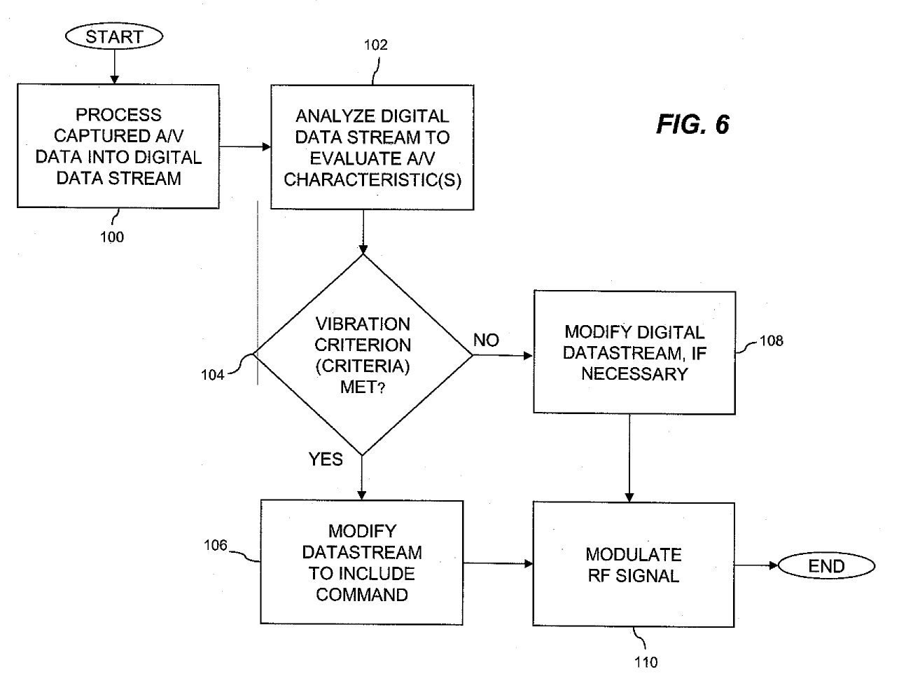

FIGS. 6-8 generally depict exemplary methods and techniques that may be implemented via one or more of the processors described above, in operation either alone or in combination. The techniques are generally directed to alternative embodiments and aspects of the disclosure for initiating a vibration alert.

At the outset, it should be noted that the processor steps described below need not be performed in the order shown. For example, the steps may be performed concurrently or in any desired processing order. The steps may be implemented by a processor with respect to different data packets at different stages of the procedure. The resulting parallel or other non-serial processing of each data packet (or other data group) may lead to more efficient processing. As a result, one step may be repeated any number of times to process a number of packets before the processor proceeds to perform a different step, which need not be the next step in the sequence shown in the figures. Alternatively, steps may be skipped or delayed, as desired or warranted. In each of these cases, one or more memories may be used to store the data and data packets as the steps of the technique are implemented.

With reference now to FIG. 6, the steps taken by one or more processors of a child unit are described in connection with an embodiment in which a vibration alert command is transmitted along with A/V data captured at the monitoring site. Thus, the processor(s) may be programmed or otherwise configured for directing the data capture, the data analysis, and the vibration alert command generation, via the exemplary steps described below.

This exemplary technique may begin in a block 100 in which the processor(s) processes the captured A/V data into a digital data stream. Such processing may include, for example, putting the captured A/V data into a form useable by other components of the device, as well as making any desired corrections (e.g., color corrections). The digital data stream may, but need not, be already arranged in the form of packets, as described above. The organization or other aspects of these packets may differ from the packets as they are arranged for transmission. In any case, one or more data stream portions or packets are then analyzed and further processed in a block 102 in accordance with an evaluation technique directed to whether a vibration alert should be initiated. The technique may involve or include any number of calculations regarding one or more selected or predetermined A/V characteristics, upon which the determination is based. The calculations may include the quantification of an A/V characteristic based on any number of aspects of the underlying A/V data. A decision block 104 then determines whether the A/V characteristics meet the criterion or criteria for initiating a vibration alert. If so, the data stream is modified in a block 106 to include a vibration alert command. The modification may involve the incorporation, insertion or addition of a packet, or the modification or a preexisting packet, as described above. If the criterion or criteria are not met, then control passes to a block 108, in which the data stream may also be modified to reflect the absence of a vibration alert. Alternatively, the data stream may be modified to include an instruction to stop an ongoing alert. In any case, the blocks 106 and 108 may also include or involve steps taken toward processing the data stream into data packets suitable for RF transmission. The technique ends—at least for the current group of packets—with the processor(s) directing or otherwise facilitating the modulation of an RF signal in a block 110 in accordance with the results of the processing of the block 106, the block 108 or both. In some cases, the block 110 includes the application of compression algorithms for more efficient data transmission.

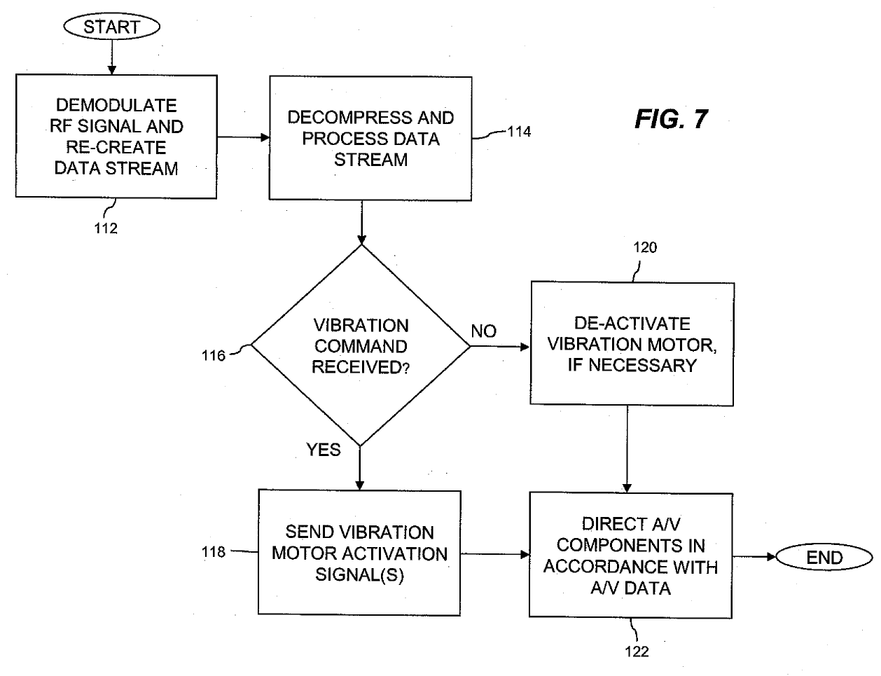

Turning to FIG. 7, the steps performed by one or more processors of a caregiver unit are depicted in accordance with an exemplary embodiment in which a vibration alert command is generated by the child unit. Upon reception of an incoming RF signal, the processor(s) may direct or otherwise facilitate the demodulation of the RF signal in a block 112 to re-create the digital data stream (or data stream packets). The processor(s) may then decompress and otherwise process the data in the data stream in a block 114, which may involve parsing packets containing more than one data type (e.g., both A/V data and command data). A decision block 116 then determines whether the received data includes a vibration alert command. If so, the processor may generate and send a vibration motor activation signal (or command) in a block 118 to a vibration motor drive or other component of a vibration motor assembly. If not, the processor may send a similar signal (or command) in a block 120 to the motor drive or assembly to de-activate the motor, if necessary to stop an ongoing alert. In either case, control eventually passes to a block 122 to direct the operation of the other components of the caregiver unit for playback of the captured sounds or images in accordance with the A/V data. In some cases, implementation of the block 122 for a given set of data (or data packets) may occur before the performance of the steps of the blocks 116, 118, and 120 relating to the vibration alert command.

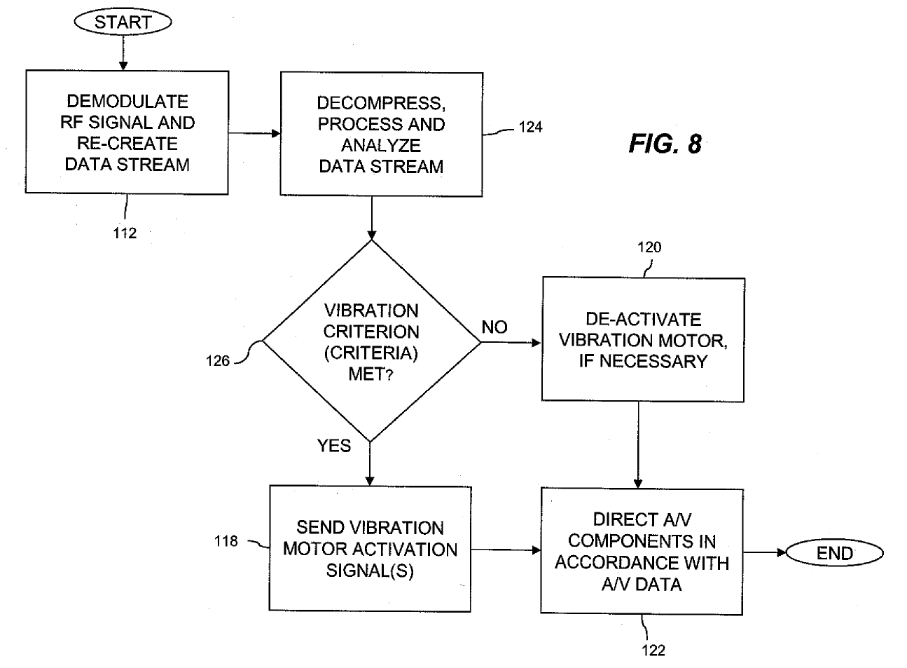

FIG. 8 depicts the steps performed by one or more processors of a caregiver unit configured to implement a vibration alert determination and, thus, generate a vibration alert command based on its analysis of the A/V data received from the child unit. Some of the steps both upstream and downstream of the vibration alert determination are similar, if not identical, to those performed in the exemplary embodiment of FIG. 7. For example, the control of an RF receiver (block 112), vibration motor (blocks 118, 120) and A/V components (block 122) may be in common with the processing steps described above.

The technique of FIG. 8 includes further analysis and related processing in a block 124, which may follow the demodulation and other processing implemented in the block 112. The analysis is generally directed to the vibration alert determination, and may therefore include or involve any number of characteristics of the A/V data received by the caregiver unit. A decision block 126 then determines whether the criterion or criteria for a vibration alert are met. Control then accordingly passes to the blocks 118, 120 and 122 as described above.

The processing steps implemented in one or more of the blocks 124, 126 and 118 generally involves the generation of a vibration alert command based on the analysis implemented in the block 124.

It should be noted that the use of the terms “A/V data,” “A/V characteristic” and the like are not limited to any data type or format. A/V data or an A/V characteristic may refer to data or information relating to, for instance, (i) only the audio captured at the monitor site, (ii) only the images captured at the monitor site, or (iii) both audio and images captured at the monitor site. Moreover, regardless of whether both audio and images are captured at the monitoring site, the A/V characteristic(s) involved in the vibration alert determination may be limited to those relating to, for instance, (i) only the audio captured at the monitor site, (ii) only the images captured at the monitor site, or (iii) both audio and images captured at the monitor site. As described above, the disclosed systems, devices and techniques may involve the user selection or adjustment of one or more A/V characteristics for use in the vibration alert determination.

A monitor system having a child unit with the functionality to capture image data need not communicate with a caregiver unit with the functionality to display the captured images. For example, such monitor systems may have more than one caregiver unit, such as a base caregiver unit with an LCD display and a mobile caregiver unit without an LCD display but otherwise capable of generating vibration alerts based on the captured audio data, the captured image data, or both.

Components of the disclosed systems, devices, and methods may be implemented in hardware, firmware, software, or any combination thereof. Some embodiments may be implemented as computer programs executing on programmable systems comprising at least one processor, and a data storage system (including volatile and non-volatile memory and/or storage elements). For purposes of this application, any processor includes any device or system that includes any number of processors or processing elements, such as, for example, a digital signal processor (DSP), a microcontroller, an application specific integrated circuit (ASIC), or a microprocessor.

The programs may be implemented in any programming language to communicate with the processors described herein. The programs may also be implemented in assembly or machine language, if desired. In fact, practice of the disclosed system and method is not limited to any particular programming language or programming technique. In any case, the language may be a compiled or interpreted language.

The programs may be stored on any type and number of storage media or devices (e.g., read only memory (ROM), flash memory device, etc.) readable by a general or special purpose programmable processor, for configuring and operating the processor when the storage media or device is read by the processor to perform the procedures described herein. The storage media or devices may, but need not, be integrated with the processors described herein. Embodiments of the disclosed systems, devices, and methods may also be considered to be implemented as a machine-readable storage medium, configured for use with a processor, where the storage medium so configured causes the processor to operate in a specific and predefined manner to perform the functions described herein.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

Although certain devices, systems and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A child monitor device, comprising:
a receiver to receive a wireless signal comprising audio data indicative of sounds captured at a remote location, the receiver comprising a demodulator to derive a digital data stream from the wireless signal;
a processor coupled to the receiver to obtain the digital data stream and configured to analyze the digital data stream to determine whether to initiate a vibration alert;
a vibration motor to vibrate the child monitor device in accordance with the vibration alert;
a digital-to-analog converter coupled to the microprocessor to receive the audio data from the digital data stream for conversion; and
a speaker output coupled to the digital-to-analog converter to reproduce the sounds captured at the remote location in accordance with the audio data.

2. The child monitor device of claim 1, wherein the processor is configured to determine whether to initiate the vibration alert based on whether the digital data stream comprises a vibration alert command.

3. The child monitor device of claim 2, wherein the processor is configured to decompress the digital data stream to seek a vibration alert command transmitted in a packet of the digital data stream separately from audio data packets of the digital data stream carrying the audio data.

4. The child monitor device of claim 1, wherein the processor is configured to detect a characteristic of the audio data to determine whether to initiate the vibration alert.

5. The child monitor device of claim 1, wherein the wireless signal further comprises image data indicative of images captured at the remote location.

6. The child monitor device of claim 5, wherein the processor is configured to detect a characteristic of the image data to determine whether to initiate the vibration alert.

7. The child monitor device of claim 6, wherein the characteristic is indicative of a brightness difference in the images captured in successive frames of the image data.

8. The child monitor device of claim 6, wherein the characteristic is indicative of a color difference in the images captured in successive frames of the image data.

9. The child monitor device of claim 6, wherein the characteristic is indicative of motion between the images captured in successive frames of the image data.

10. A child monitor system, comprising:
a first unit comprising a transducer to capture sounds, an analog-to-digital converter to generate digital audio data representative of the sounds, and an RF transmitter to generate an RF signal carrying the digital audio data;
a second unit configured to receive the RF signal wirelessly and comprising a vibration motor and an RF receiver to derive a digital data stream from the RF signal;
wherein—
the first unit further comprises a processor configured to generate a vibration alert command based on an analysis of the digital audio data and configured to provide the vibration alert command to the RF transmission module for incorporation in the RF signal;
the second unit further comprises a processor to control operation of the vibration motor in accordance with the vibration alert command.

11. The child monitor system of claim 10, the processor of the first unit is configured to detect a characteristic of the audio data to determine whether to initiate the vibration alert.

12. The child monitor system of claim 10, wherein the first unit further comprises a camera such that the RF signal further comprises image data indicative of images captured by the camera.

13. The child monitor system of claim 12, wherein the processor of the first unit is configured to detect a characteristic of the image data to determine whether to initiate the vibration alert.

14. The child monitor system of claim 13, wherein the characteristic is indicative of a brightness difference in the images captured in successive frames of the image data.

15. The child monitor system of claim 13, wherein the characteristic is indicative of a color difference in the images captured in successive frames of the image data.

16. The child monitor system of claim 13, wherein the characteristic is indicative of motion between the images captured in successive frames of the image data.

17. A child monitor method, comprising:
generating a digital data stream comprising audio data representative of captured sounds and image data representative of captured images;
evaluating a characteristic of the digital data stream via analysis of the digital data stream; and
generating a vibration alert command in accordance with the analysis.

18. The child monitor method of claim 17, further comprising the step of modifying the digital data stream to include the vibration alert command.

19. The child monitor method of claim 18, further comprising the step of receiving an RF signal representative of the modified digital data stream, and wherein the evaluating step comprises determining whether the vibration alert command is included within the modified digital data stream.

20. The child monitor method of claim 17, further comprising the step of receiving an RF signal representative of the digital data stream, and wherein the evaluating step is performed after the receiving step.

21. A child monitor system, comprising:
a first unit comprising a microphone to capture audio data, a camera to capture video data, and an RF transmitter to generate an RF signal carrying the audio data and the video data; and
a second unit comprising an RF receiver to generate a digital data stream from the RF signal, a vibration motor, and a processor to analyze the digital data stream to control operation of the vibration motor;
wherein the operation of the vibration motor is controlled based on an audio/video (A/V) characteristic of either the audio data or the video data.
